(19) United States
(12) Patent Application Publication
(10) Pub. No.: US 2014/0326215 A1
(43) Pub. Date: Nov. 6, 2014

(54) Arrangement of an Air Supply Device on a Cylinder Head for an Internal Combustion Engine

(71) Applicants: Jochen Haefner, Lorch (DE); Cecile Jecker, Esslingen (DE)

(72) Inventors: Jochen Haefner, Lorch (DE); Cecile Jecker, Esslingen (DE)

(73) Assignee: Daimler AG, Stuttgart (DE)

(21) Appl. No.: 14/352,604

(22) PCT Filed: Sep. 5, 2012
(86) PCT No.: PCT/EP2012/003709

§ 371 Date: Apr. 17, 2014

(30) Foreign Application Priority Data
Oct. 18, 2011 (DE) 10 2011 116 310.0

(51) Int. Cl. F02M 35/10; F02B 29/04; F02M 35/16; F02B 33/00

(52) U.S. Cl. CPC F02M 35/10209; F02B 33/00; F02B 29/04; F02M 35/16; F02M 35/10288
USPC 123/403; 123/559.1; 123/563

(57) ABSTRACT

An arrangement of an air supply device on a cylinder head for an internal combustion engine involves the air supply device including an intake device for distributing air, which is to be supplied to combustion chambers of the engine, and a compressor for compressing the air. The compressor is fluidically connected to the intake device via an air duct element. The air supply device is mounted on the cylinder head and extends over the cylinder head from the intake device situated on an air side of the cylinder head, via the air duct element, to the compressor situated on an exhaust gas side of the cylinder head, forming an intermediate space that is delimited by the intake device, the air duct element, and the compressor. The cylinder head is at least partially situated in this intermediate space.

### CROSS-REFERENCE TO RELATED APPLICATION

The present application is related to PCT/EP2012/003710, filed Sep. 5, 2012, a national stage application of which is filed as U.S. application Ser. No. ______, on even date herewith (Attorney Docket No. 095309.66392US).

### BACKGROUND AND SUMMARY OF THE INVENTION

Exemplary embodiments of the present invention relate to an arrangement of an air supply device on a cylinder head for an internal combustion engine.

German patent document DE 44 03 219 A1 discloses an intake module for a multiple-cylinder internal combustion engine, which may be preassembled as an integral unit, into which injectors are integrated and which may be flanged to a cylinder head of the internal combustion engine and has a divided housing which has a lower part, an upper part connected thereto in a sealing manner, and at least one air inlet. The air inlet is connected via an intake duct to multiple air tubes having outlet openings. For injecting fuel, the injectors are situated in the air tubes within the housing, adjacent to the outlet openings of the air tubes. An intake air filter is situated in the housing, between an uncontrolled air side and a clean air side, and the portion of the intake duct on the clean air side, in addition to the air collection duct and at least sections of the air tubes leading away therefrom, are molded into the upper part of the housing.

German patent document DE 37 30 817 C2 discloses a cylinder head cover together with an intake manifold system for an internal combustion engine having a four-stroke reciprocating piston design that form an integral unit. The cylinder head cover of this integral unit is mounted on a cylinder head of the internal combustion engine by means of a seal and by screws. The screw heads are screwed into coaxially situated fastening screws that hold the multi-part cylinder head in position.

In addition, these types of arrangements of air supply devices on corresponding cylinder heads of internal combustion engines are known from the series production of motor vehicles, in which the air supply devices each include an intake device for distributing air, which is to be supplied to the internal combustion engine, to combustion chambers of the internal combustion engine, and a compressor for compressing the air. The compressor is fluidically connected to the intake device via an air duct element, so that air may flow between the intake device and the compressor.

These known arrangements have undesirably high space requirements that may result in package problems, in particular in a space-critical area such as in an engine compartment of a motor vehicle.

Exemplary embodiments of the present invention are directed to an arrangement of an air supply device on a cylinder head for an internal combustion engine of the type mentioned at the outset in such a way that the arrangement has particularly low space requirements.

In such an arrangement of an air supply device on a cylinder head for an internal combustion engine, in particular of a motor vehicle and especially a passenger vehicle, the air supply device includes an intake device. The intake device is used for distributing air, which is to be supplied to the internal combustion engine, to combustion chambers, in particular cylinders of the internal combustion engine.

The air supply device also includes a compressor, of an exhaust gas turbocharger, for example, by means of which the air to be supplied to the internal combustion engine is compressed. The compressor is fluidically connected to the intake device via an air duct element. Thus, for example, compressed air may flow from the compressor to the intake device, which may then distribute the compressed air to the combustion chambers.

According to the invention, the air supply device mounted on the cylinder head extends over the cylinder head, i.e., in the vertical direction above the cylinder head, starting from the intake device situated on an air side of the cylinder head, via the air duct element, to the compressor situated on an exhaust gas side of the internal combustion engine, forming an intermediate space that is delimited by the intake device, the air duct element, and the compressor. The cylinder head is at least partially situated in the intermediate space. This means that, for example, a cylinder head cover of the cylinder head and/or at least some other partial area of the cylinder head is/are situated in the intermediate space. Due to this arrangement of the air supply device and its components, i.e., the compressor, the intake device, and the air duct element, a very compact and space-saving arrangement is provided having only very short line lengths via which the air is supplied to the combustion chambers.

As a result of the particularly compact arrangement, package problems, in particular in a space-critical area such as an engine compartment of the motor vehicle, are eliminated and/or avoided. The very short line lengths results in a particularly small intake volume, which benefits the dynamics, i.e., the response characteristic, and thus the performance of the internal combustion engine. Due to the compact arrangement, the air supply device has short response times with respect to changes in the quantity of intake air, in particular during acceleration of the motor vehicle, which result in the advantageous dynamics.

The arrangement according to the invention also has only a very small number of parts for conducting the air and for connecting the components of the air supply device, i.e., the intake device, the compressor, and the air duct element. This results in particularly low costs and low weight of the arrangement according to the invention. The small number of parts also results in a particularly small number of interfaces, so that the arrangement has only small tolerances, particularly good seal-tightness, and particularly high reliability in meeting its function.

The compressor, the air duct element, and the intake device extend, for example, at least essentially in an arc shape over the cylinder head. An arrangement that at least essentially has the shape of a circular arc segment, some other shape that is at least essentially circular, as well as a shape that is at least essentially polygonal may be provided, which results in the particularly low space requirements.

In another advantageous embodiment of the invention, a first connecting flange of the cylinder head via which the intake device is connected to the cylinder head, and a second connecting flange of the cylinder head via which exhaust gas may be discharged from the cylinder head, are situated in respective planes that extend upwardly toward one another in particular in the vertical direction of the internal combustion engine. In other words, the connecting flanges and the planes are angled with respect to one another. Particularly short line lengths for conducting the air are thus achievable, resulting in particularly low space requirements.

Alternatively or additionally, a third connecting flange of the intake device via which the intake device is at least indirectly connected to the cylinder head, and/or a fourth connecting flange of a turbine of the exhaust gas turbocharger that is to be driven by exhaust gas of the internal combustion engine and which drives the compressor, and via which the turbine is at least indirectly connectable or connected to the cylinder head, is/are situated in respective further planes, the further planes extending upwardly toward one another in particular in the vertical direction of the internal combustion engine. This results in particularly low space requirements of the arrangement according to the invention.

The first connecting flange of the cylinder head is referred to as an inlet flange, via which the internal combustion engine is supplied with air. The second connecting flange of the cylinder head is also referred to as an outlet flange, via which exhaust gas of the internal combustion engine is discharged, and supplied, for example, to the turbine of the exhaust gas turbocharger.

The compressor, which is to be driven by the turbine by means of exhaust gas from the internal combustion engine, may be associated with the exhaust gas turbocharger. Due to the angled orientation of the outlet flange and the inlet flange with respect to one another, a very short line length from the exhaust gas turbocharger on the outlet side (outlet flange) at least essentially directly on the cylinder head to the charge air cooler on the inlet side (inlet flange) at least directly on the cylinder head may be achieved. This benefits the low space requirements of the arrangement.

In another advantageous embodiment, a cooling device, in particular a charge air cooler, for cooling the air compressed by the compressor is integrated into the intake device. The cooling device is used for increasing the supercharging rate of the air, since it recools the air that is compressed and thus heated. Due to the integration of the cooling device into the intake device, the intake device has a particularly high level of functional integration, which keeps its number of parts, weight, and costs low. In addition, this integration allows particularly simple and thus time- and cost-effective assembly, since the intake device and optionally the air duct element and/or compressor connected to it may be preassembled as a modular component and installed, i.e., fastened, as a preassembled modular component on the cylinder head in a time- and cost-effective manner. The preassembly of the modular component may at the same time accompany, at least in part, the installation of the cylinder head or the rest of the internal combustion engine, so that the overall internal combustion engine may be manufactured in a short period of time and thus in a cost-effective manner.

In one advantageous embodiment of the invention, the air duct element includes a throttle valve element having a throttle valve and an actuator for actuating the throttle valve. A cross-section through which air that is to be supplied to the internal combustion engine may flow may be variably set by means of the throttle valve. Due to this integration, the air duct element has a very high level of modularity and a high level of functional integration, which keeps the weight, the number of parts, and the costs low.

In another advantageous embodiment, the air duct element includes a silencer as an air guide element. In other words, the silencer, through which the air flows, is used for damping noise, so that the internal combustion engine has a very good noise characteristic. This benefits driving comfort for occupants of the motor vehicle.

In another embodiment, an oil separator is integrated into the intake device. The oil separator is used to separate an oil component of an oil-gas mixture from a gas component of the mixture. The oil separator may thus be used within the scope of so-called crankcase venting of a crankcase of the internal combustion engine in which so-called blow-by gas containing the oil-gas mixture is exhausted from the crankcase and supplied to the oil separator. The oil separator then at least predominantly separates the oil component from the gas component. The oil component may then be resupplied to an oil circuit of the internal combustion engine. The gas may be supplied to an intake tract, in particular the air duct element, and via same to the combustion chambers of the internal combustion engine.

Due to the integration of the oil separator into the intake device, the installation of the intake device on the cylinder head is accompanied by the installation of the oil separator on the cylinder head. In other words, no additional time- and cost-intensive installation steps are necessary for separately fastening the oil separator to the cylinder head. This keeps the assembly costs low. In addition, the arrangement thus has particularly low space requirements.

In another advantageous embodiment, a cylinder head cover by means of which the cylinder head is to be at least partially covered is integrated into the intake device. Due to this integration, additional, separate assembly operations for fastening the cylinder head cover to the cylinder head are dispensed with, since the cylinder head cover is installed on the cylinder head at the same time that the intake device or the entire air supply device is installed on the cylinder head. The described integration has the further advantage that the number of interfaces may thus be kept particularly small. This facilitates the seal-tightness of the air supply device as well as small tolerances of same.

In one particularly preferred embodiment, parts of the housing, in particular the upper housing part and the lower housing part, are connected to one another by screwing and/or welding, and/or gluing and/or riveting, and/or these parts are at least partially formed together as one piece. A particularly permanently seal-tight and easy connection of the housing parts to one another may be achieved using these connection technologies. In particular for connecting housing parts made of plastics, metallic connecting elements may be at least partially dispensed with when these parts are welded. The overall weight of the system may thus be kept low.

Further advantages, features, and particulars of the invention result from the following description of one preferred exemplary embodiment and with reference to the drawings. The features and feature combinations mentioned above in the description as well as the features and feature combinations mentioned below in the description of the figures and/or only shown in the figures may be used not only in the particularly stated combination, but also in other combinations or alone without departing from the scope of the invention.

### BRIEF DESCRIPTION OF THE DRAWING FIGURES

The drawings show the following:

FIG. 1 shows a schematic front view of an air supply device for arranging on a cylinder head of an internal combustion engine, whereby, with reference to the installation position of the air supply device on the cylinder head, an intake device of the air supply device situated on an air side or outlet side of the cylinder head extends over the cylinder head via an air duct element to a compressor situated on an exhaust gas side or outlet side of the cylinder head, forming an intermediate space that is delimited by the intake device, the air duct element, and the compressor, and whereby the cylinder head is to be at least partially situated in the intermediate space; and

FIG. 2 shows a schematic sectional view of the air supply device according to FIG. 1.

### DETAILED DESCRIPTION

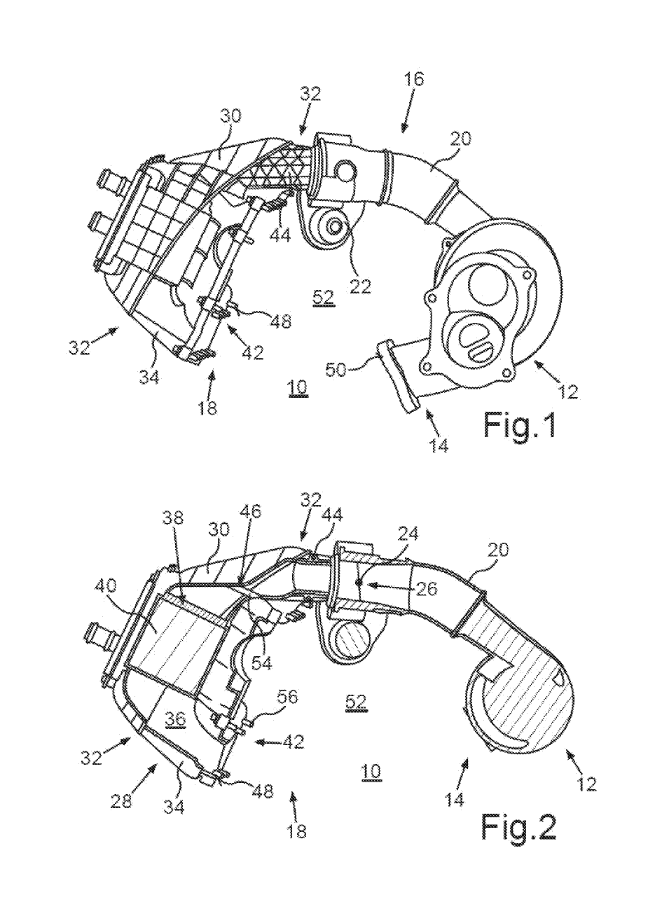

FIGS. 1 and 2 show an air supply device 10 that is to be situated on a cylinder head of an internal combustion engine designed, for example, as a reciprocating piston internal combustion engine. FIGS. 1 and 2 show the air supply device 10 in its installation position, in which the air supply device 10 is at least essentially situated in its state connected to the cylinder head or mounted thereon.

The air supply device 10 includes a compressor 12 of an exhaust gas turbocharger. Air to be supplied to the internal combustion engine is to be compressed by means of the compressor 12. For driving the compressor 12, the exhaust gas turbocharger includes a turbine drivable by exhaust gas of the internal combustion engine.

To be able to advantageously supply the turbine with the exhaust gas, the exhaust gas turbocharger and thus the compressor 12 are situated on an outlet side 14 of the cylinder head, not illustrated in FIGS. 1 and 2. Exhaust gas flows out from the internal combustion engine via the cylinder head on the outlet side 14. The outlet side 14 is also referred to as the exhaust gas side.

The air supply device 10 also includes an air duct element 16 by means of which the air that is compressed by the compressor 12 is to be conducted to an inlet side 18 of the cylinder head and the internal combustion engine. The inlet side 18 is also referred to as the intake side or air side. The air duct element 16 includes a silencer 20 fluidically connected to the compressor 12. Compressed air may thus flow from the compressor 12 and into and through the silencer 20.

The air duct element 16 also includes a throttle valve actuator 22 having a throttle valve 24. The throttle valve actuator 22 is fluidically connected to the silencer 20, so that the air may flow from the silencer 20 into and through the throttle valve actuator 22. The throttle valve 24 is used to variably set a flow cross-section 26 through which the air may flow. Thus, for example, a load or a torque of the internal combustion engine designed as a spark ignition engine, for example, may be set by the driver of the motor vehicle.

The air supply device 10 also includes an intake device 28 that is at least essentially situated on the inlet side 18 of the cylinder head and thus of the internal combustion engine. The intake device 28 includes an upper housing part 30 and a lower housing part 34, which is connected to the upper housing part 30 via respective connecting flanges 32. Air channels 36 via which the compressed air may be supplied to the internal combustion engine are partially delimited in each case by the upper housing part 30 and the lower housing part 34. In addition, a receiving chamber 38 is partially delimited in each case by the upper housing part 30 and the lower housing part 34. A charge air cooler 40 is situated in the receiving chamber 38. This means that the charge air cooler 40 is integrated into the intake device 28. The charge air cooler 40 is used to cool the air which is compressed and thus heated.

The intake device 28, which is also referred to as an intake module, also has a charge air distributor 42 by means of which the compressed air is distributed to combustion chambers of the internal combustion engine that are designed as cylinders. In other words, the air may flow from the receiving chamber 38 via the charge air distributor 42 and into the combustion chambers (cylinders) of the internal combustion engine. The intake device 28 has a connector 44 for fluidically connecting the intake device 28 to the throttle valve actuator 22.

An oil separator 46 by means of which an oil component is to be separated from a gas component of an oil-gas mixture within the scope of crankcase venting is also integrated into the intake device 28. For fluidically connecting the intake device 28 to the cylinder head or to the combustion chambers, the intake device 28 has a first connecting flange situated in a first plane 48. There is a corresponding second connecting flange of the cylinder head via which the intake device 28 is connected or connectable to the cylinder head via the first connecting flange. The second connecting flange of the cylinder head is situated in a second plane that extends at least essentially parallel to the first plane 48.

For fluidically connecting the turbine to the cylinder head or to the combustion chambers so that the exhaust gas may be supplied to the turbine, the turbine has a third connecting flange situated in a third plane 50. There is a corresponding fourth connecting flange of the cylinder head via which the cylinder head may be connected to the turbine via the third connecting flange. The fourth connecting flange is situated in a fourth plane extending at least essentially parallel to the third plane 50.

As is apparent with reference to FIG. 1, the planes 48, 50 extend upwardly, with reference to the installation position of the air supply device 10, toward one another in the vertical direction of the cylinder head and thus of the internal combustion engine. In other words, the planes 48, 50 are angled with respect to one another and toward one another. The same applies for the third plane and the fourth plane of the cylinder head, which are angled with respect to one another corresponding to the planes 48, 50 in such a way that the planes extend upwardly toward one another in the vertical direction of the cylinder head. Due to this angled orientation of the connecting flanges with respect to one another, very short line lengths from the exhaust gas turbocharger on the outlet side 14 to the charge air cooler 40 on the inlet side 18 are achieved, via which the air is conducted from the compressor 12 to the intake device 28. In particular, the length of the air conduction may be kept very small by means of the air duct element 16.

As is also apparent from FIGS. 1 and 2, the air supply device 10, which is mounted on the cylinder head, extends over the cylinder head from the intake device 28 situated on the inlet side 18 of the cylinder head via the air duct element 16 to the compressor 12 situated on the outlet side 14 of the cylinder head, forming an intermediate space 52 that is delimited by the intake device 28, the air duct element 16, and the compressor 12. The cylinder head may be at least partially situated in the intermediate space. A very compact arrangement is thus provided, as the result of which package problems, in particular in a space-critical area such as an engine compartment of the motor vehicle, may be eliminated and/or avoided.

For mounting in particular the intake device 28 on the cylinder head, screws 54, 56 are used which are screwed into the cylinder head. The screws 54 are also used for connecting the upper housing part 30 to the lower housing part 34. For this purpose, the screws 54 pass through respective through openings in the upper housing part 30 and the lower housing part 34, and are screwed into the cylinder head. The upper housing part 30 is thus clamped to the lower housing part 34. It is likewise conceivable for the upper housing part 30 and the lower housing part 34 to be connected to one another by screwing, welding, gluing, and/or riveting, and/or for these parts to be at least partially formed together as one piece.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

10 Air supply device

### 12 Compressor

14 Outlet side
16 Air duct element
18 Inlet side

### 20 Silencer

22 Throttle valve actuator
24 Throttle valve
26 Flow cross section
28 Intake device
30 Upper housing part
32 Connecting flanges
34 Lower housing part
36 Air channel
38 Receiving chamber
40 Charge air cooler
42 Charge air distributor

### 44 Connector

46 Oil separator
48 First plane
50 Second plane
52 Intermediate space

### 54 Screw

54 Screw

1-9. (canceled)

10. An arrangement of an air supply device on a cylinder head for an internal combustion engine, wherein:
the air supply device includes
an intake device configured to distribute air supplied to combustion chambers of the internal combustion engine, and
a compressor configured to compress the air, wherein the compressor is fluidically connected to the intake device via an air duct element,
the air supply device is mounted on the cylinder head and extends over the cylinder head from the intake device situated on an air side of the cylinder head, via the air duct element, to the compressor situated on an exhaust gas side of the cylinder head, forming an intermediate space delimited by the intake device, the air duct element, and the compressor,
the cylinder head is at least partially situated in the intermediate space,
a first connecting flange of the cylinder head via which the intake device is connected to the cylinder head, and a second connecting flange of the cylinder head via which exhaust gas may be discharged from the cylinder head, are situated in respective planes that extend upwardly toward one another a vertical direction of the internal combustion engine,
an upper housing part and a lower housing part of the air supply device are connected to one another by screwing, welding, gluing, or riveting, or the upper and lower housing parts are at least partially formed together as one piece.

11. The arrangement of claim 10, wherein a cooling device configured to cool the air compressed by the compressor is integrated into the intake device.

12. The arrangement of claim 10, wherein the air duct element includes a throttle valve element having a throttle valve and an actuator configured to actuate the throttle valve.

13. The arrangement of claim 10, wherein the air duct element includes a silencer as an air guide element.

14. The arrangement of claim 10, wherein an oil separator is integrated into the intake device.

15. The arrangement of claim 10, wherein a cylinder head cover is integrated into the intake device.

16. An motor vehicle internal combustion engine, comprising:
a cylinder head of the internal combustion engine; and
an air supply device arranged on the cylinder head of the internal combustion engine, wherein
the air supply device includes
an intake device configured to distribute air supplied to combustion chambers of the internal combustion engine, and
a compressor configured to compress the air, wherein the compressor is fluidically connected to the intake device via an air duct element,
the air supply device is mounted on the cylinder head and extends over the cylinder head from the intake device situated on an air side of the cylinder head, via the air duct element, to the compressor situated on an exhaust gas side of the cylinder head, forming an intermediate space delimited by the intake device, the air duct element, and the compressor,
the cylinder head is at least partially situated in the intermediate space,
a first connecting flange of the cylinder head via which the intake device is connected to the cylinder head, and a second connecting flange of the cylinder head via which exhaust gas may be discharged from the cylinder head, are situated in respective planes that extend upwardly toward one another a vertical direction of the internal combustion engine,
an upper housing part and a lower housing part of the air supply device are connected to one another by screwing, welding, gluing, or riveting, or the upper and lower housing parts are at least partially formed together as one piece.

17. The motor vehicle internal combustion engine of claim 16, wherein a cooling device configured to cool the air compressed by the compressor is integrated into the intake device.

18. The motor vehicle internal combustion engine of claim 16, wherein the air duct element includes a throttle valve element having a throttle valve and an actuator configured to actuate the throttle valve.

19. The motor vehicle internal combustion engine of claim 16, wherein the air duct element includes a silencer as an air guide element.

20. The motor vehicle internal combustion engine of claim 16, wherein an oil separator is integrated into the intake device.

21. The motor vehicle internal combustion engine of claim 16, wherein a cylinder head cover is integrated into the intake device.
